(19) United States
(12) Patent Application Publication
(10) Pub. No.: US 2016/0299969 A1
(43) Pub. Date: Oct. 13, 2016

(54) System and Method for Generating Personalized Tones

(71) Applicant: Steven Joyner, Los Angeles, CA (US)

(72) Inventor: Steven Joyner, Los Angeles, CA (US)

(21) Appl. No.: 14/680,294

(22) Filed: Apr. 7, 2015

(51) Int. Cl. G06F 17/30; G06Q 30/02; H04M 19/04

(52) U.S. Cl. CPC G06F 17/30746; H04M 19/04; G06Q 30/0256

(57) ABSTRACT

There is provided a system and method for generating personalized tones using artists and sponsors. The system including a memory storing a software application and a processor configured to execute the software application to present at least one question. The processor is further configured to execute the software application to receive a first input including a response to the at least one question, transmit the response to the at least one question to a server, and receive a tone from the server. The tone including lyrics generated based at least in part on the response to the at least one question.

### BACKGROUND OF THE INVENTION

1. Field of the Invention

The present invention relates generally to the generation of tones. More particularly, the present invention relates to a system and method for generating personalized tones.

2. Background Art

Nowadays, custom tones for mobile devices and the like have become increasingly popular among users of mobile phones. Current software applications allow the users to program tones into their mobile devices that play each time they receive an incoming call or text, or that play in response to an alarm or notification. For example, the users may utilize these software applications to program one general tone that applies to all contacts in their mobile device, or users may utilize these software applications to set different tones for each contact. As such, these software applications provide users with the ability to customize their mobile devices to create a personalized and unique user experience.

However, current software applications that allow users to program custom tones into mobile devices also have a lot of drawbacks. For example, current software applications only allow users to select from a given set of tones, which consist of copyrighted songs from other artists, or to create their own low-quality tones using their own mobile device. As such, users are not able to create their own high-quality personalized tones to personalize their mobile devices. Furthermore, since tones are generally copyrighted songs, users are required to pay for each tone downloaded which becomes expensive.

Accordingly, there is a need to overcome the drawbacks and deficiencies in the art by providing a way for users of mobile devices to receive their own personalized tones that are free of charge to the users.

### SUMMARY OF THE INVENTION

There is provided a system and method for generating personalized tones, substantially as shown in and/or described in connection with at least one of the figures, and as set forth more completely in the claims.

### BRIEF DESCRIPTION OF THE DRAWINGS

FIG. 1 presents a system for generating personalized tones, according to one implementation of the present disclosure.

FIG. 2 presents an example of a user device that may be used to generate personalized tones, according to one implementation of the present disclosure.

FIG. 3 presents an example of a server that may be used to generate personalized tones, according to one implementation of the present disclosure.

FIG. 4 shows a flowchart illustrating a method for using a user device to generate personalized tones, according to one implementation of the present disclosure.

FIG. 5 shows a flowchart illustrating a method for a server to generate personalized tones, according to one implementation of the present disclosure.

FIG. 6 shows a flowchart illustrating a method for an organization to create a network of customers and/or users to generate targeted advertisements, according to one implementation of the present disclosure.

### DETAILED DESCRIPTION OF THE INVENTION

The following description contains specific information pertaining to implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

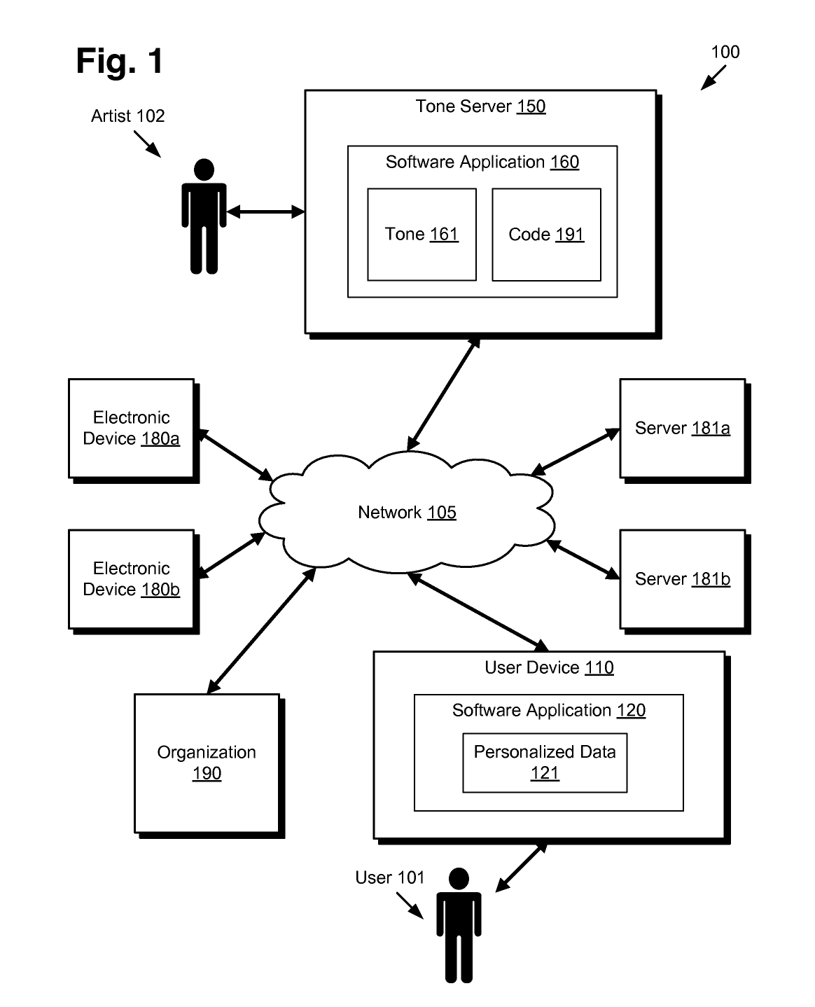

FIG. 1 presents a system for generating personalized tones, according to one implementation of the present disclosure. System 100 of FIG. 1 includes user 101, artist 102, network 105, user device 110, electronic device 180a and electronic device 180b (collectively referred to as electronic device 180), organization 190, and server 181a and server 181b (collectively referred to as servers 181). User device 110 includes software application 120, which includes personalized data 121. Server 150 includes software application 160, which includes tone 161 and code 191.

In the implementation of FIG. 1, user 101 in possession of user device 110 may use software application 120 to create personalized tones. In order to create a personalized tone, software application 120 first queries user 101 to respond to a series of questions, which may include the name of user 101, the location of user 101, and any hobbies that user 101 has, for example. Software application 120 may then ask user 101 to select an advertisement and a song that user 101 wishes to include in the personalized tone. In an implementation where user 101 includes multiple users, each user may select an advertisement and a song. Finally, software application 120 packages all of that data as personalized data 121 and transmits personalized data 121 over network 105 to tone server 150, where network 105 includes any type of wired or wireless network, such as the Internet.

It should be noted, as mentioned above, that user 101 may include one or more users. For example, in some implementations, user 101 is an individual user who desires tone 161 to be personalized to him/her. However, in other implementations, user 101 may be any number of users that desire tone 161 to be personalized to all of them, or a few of them. For example, if user 101 includes five persons, tone 161 may be personalized to include information about each of the five persons.

Continuing with the implementation of FIG. 1, tone server 150 may use personalized data 121 received from mobile device 110 to generate a personalized tone for user 101 of mobile device 110, such as tone 161. In order to generate tone 161 for user 101, tone server 160 transmits personalized data 121 to artist 102, where artist 102 includes a singer. Artist 102 then uses at least one answer to the series of questions answered by user 101 and the selected advertisement from personalized data 121 to create and record lyrics for tone 161. Creating the lyrics for tone 161 may include artist 102 writing the lyrics and singing the lyrics, or may include a computer and/or server, such as tone server 150, creating the lyrics utilizing personalized data 121.

In implementations where user 101 includes more than one person, artist 102 may select one advertisement and one song from the group of advertisements and songs selected user 101. Artist 102 may select an advertisement or song that was selected by user 101 more than one time, or with the greatest frequency.

After recording the lyrics for tone 161 based at least in part on personalized data 121, artist 102 transmits the lyrics to tone server 150. Tone server 150 then uses the lyrics generated by artist 102 and at least and instrumental of the song selected by user 101 to generate tone 161.

For example, in one implementation, tone 161 includes background or instrumental music from the song selected by user 101 along with the lyrics provided by artist 102. In such an implementation, tone 161 may include a forty second tone, with the first ten seconds of the lyrics being dedicated to the advertisement and the final thirty seconds of the lyrics being dedicated primarily to information about user 101. In yet another implementation, the lyrics of tone 161 may include information relating to the advertisement during another time frame of tone 161, or sporadically at different times within tone 161.

Continuing with the implementation of FIG. 1, after generating tone 161 for user 101 of mobile device 110, tone server 150 may then transmit tone 161 to mobile device 110. As will be discussed in greater detail below, transmitting tone 161 to user device 110 may include transmitting a notification to mobile device 110 that will be displayed within software application 120, where the notification notifies user 101 that tone 161 is ready to be downloaded. Clicking on the notification will then generate an email for user 101 within the default email of user 101. The email will have an attachment that user 101 can then use to download tone 161. After downloading tone 161, user 101 may then sync tone 161 to user device 110 such that tone 161 becomes the default tone of user device 110.

However, in other implementations, tone 161 may automatically download to user device 110 after tone 161 is generated. In yet another implementation, user 101 may access an application to access tone 161 and download tone 161 over network 105.

Also illustrated in the implementation of FIG. 1, system 100 includes electronic devices 180. Electronic devices 180 may include computers, mobile phones, tablets, or any other electronic devices that are capable of both downloading and playing tone 161. In one implementation, which will be described in greater detail below, electronic device 180 may be in possession of contacts for user 101 of user device 110. For example, user device 110 may include a contact list of friends for user 101. In such an example, each of electronic devices 180 may be in possession of one of the contacts from the contact list. User device 110 may then transmit one or more contacts from the contact list, along with personalized data 121, to tone server 150 and tone server 150 may further transmit tone 161 to the one or more contacts.

For example, if electronic device 180a is in possession of a first contact of user 101 and electronic device 180b is in possession of a second contact of user 101, user 101 may select the first contact and the second contact to be added in personalized data 121. In such an example, tone server 150 will further transmit tone 161 to electronic device 180a and electronic device 180b so that the first contact and the second contact can have their own copy of tone 161. When transmitting tone 161 to electronic devices 180, tone server 150 may use network 105. Furthermore, tone server 150 may use any of the methods described above (such as sending an email with a link to tone 161) with regard to user device 110, in order to inform the first and the second contact of their access to tone 161.

In the implementation of FIG. 1, system 100 further includes organization 190. Organization 190 may include any business, company, storefront, or other organization that interacts with customers and/or patrons and desires to create a personalized tone. Organization 190 can request tone server 150 to generate a personalized tone for organization 190 using software application 160. In such an implementation, user device 110, including software application 120, may be in possession of organization 190. In some implementations, organization 190 may have a personalized tone, such as tone 161, created by tone server 150 similar to user 101 having tone 161 created as discussed above.

However, in another implementation, instead of selecting an advertisement, organization 190 may request tone 161 be generated using a name and other information about organization 190 to create tone 161 as a personalized tone for organization 190. In such an implementation, tone 161 may be transmitted to electronic devices 180 along with code 191, where code 191 is personalized to organization 190. Code 191 may be embedded in metadata of tone 161, or may be transmitted along with tone 161, to customers or users of organization 190. As such, organization 190 can create a network of customers including each customer that receives tone 161 from organization 190, and each subsequent user that receives a personalized tone from each customer.

For example, after tone 161 is generated and personalized for organization 190, organization 190 may send tone 161 to Customer A. Customer A receives tone 161 from organization 190, or from tone server 150, where tone 161 includes code 191. Customer A may receive tone 161 with an offer to download software application 160 onto their device in order to create their own personalized tone. The offer may also include a discount or incentive from organization 190 that influences or persuades Customer A to download software application 160 onto their device. Once Customer A downloads software application 160, enters their personalized data, and receives a personalized tone, the personalized tone will also include code 191. Customer A may then send their personalized tone to their friends, post their personalized tone to social networking sites, and/or share their personalized tone in other ways. Each recipient of Customer A's personalized tone may then download software application 160, receive a personalized ringtone that includes code 191, and so on, until a network of persons is created from the original tone 161 generated and personalized for organization 190.

Each of the persons, including Customer A, within the network will have their user data stored on tone server 151, and made available to organization 190 for future advertisement purposes. The user data may be encrypted so organization 190 does not have direct access to personal information of the users. For example, when organization 190 wants to send an advertisement or another communication in the future, such as by text, email, or another communication means, organization 191 can access the user data on tone server 151 to generate more personalize and targeted advertisements. If the user data is encrypted, organization 190 may receive the user data in a more general and high-level form, such as by average age of the users, most common gender of the users, a most popular hobby of the users, and/or other user data. In such an implementation, the users do not have their personal information broadcast where it is not permitted or desired.

It should be noted that customers, as used herein, does not require that customers exchange money with organization 190. Customers may include any persons who interact in any way with organization 190.

It should be noted that besides tone server 150 transmitting tone 161 to electronic devices 180, user device 110 or organization 190 may also transmit tone 161 to electronic devices 180 after user device 110 receives tone 161 from tone server 150. For example, user device 110 or organization 190 may transmit tone 161 to user devices 180 using any wired or wireless technologies, such as through network 105, using Bluetooth, or across a local area network (LAN).

In the implementation of FIG. 1, system 100 further includes servers 181. Servers 181 may include sever hardware clusters or data centers connected to network 105. In one implementation, each of servers 181 may host at least one third-party service that may include social networking, such as Facebook and Twitter. Tone server 150 or user device 110 may thus share tone 161 using the third-party services hosted on servers 181. For example, after receiving tone 161 from tone server 150, user 101 of user device 110 may post tone 161 on his or her Facebook account for listening and/or downloading by friends of user 101. For another example, tone server 150 may have already received permission to post tones on the Facebook account of user 101 and as such may automatically post tone 161 on the Facebook account after tone 161 is generated.

In some implementations, user 101 may include videos and/or images of user 101 interacting with tone 161. For example, user 101 may include a video on a social networking site that includes user 101 interacting with tone 161 by lip-syncing, dancing along with, or actually singing tone 161. In such an implementation, other users of the social networking may vote on tone 161, and/or user 101 interacting with tone 161.

Sharing tone 161 on third-party services hosted by servers 181 may include posting a notification on the account of user 101 that user 101 has received tone 161. Furthermore, the notification may include a link to download tone 161 so that friends of user 101 can download their own copy of tone 161. Finally, the notification may further include a link to download software application 120 so that the friends of user 101 can also create their own personalized tones using software application 120.

It should be noted that the implementation of FIG. 1 primarily discusses creating tones that are generated by server 150; however, the present disclosure is not limited to the implementation of FIG. 1. In other implementations, user 101 may use software application 120 to generate personalized songs that can be played by user device 110 and electronic devices 180. In such implementations, tone 161 would correspond to the personalized song that is created using software application 120 by user 101.

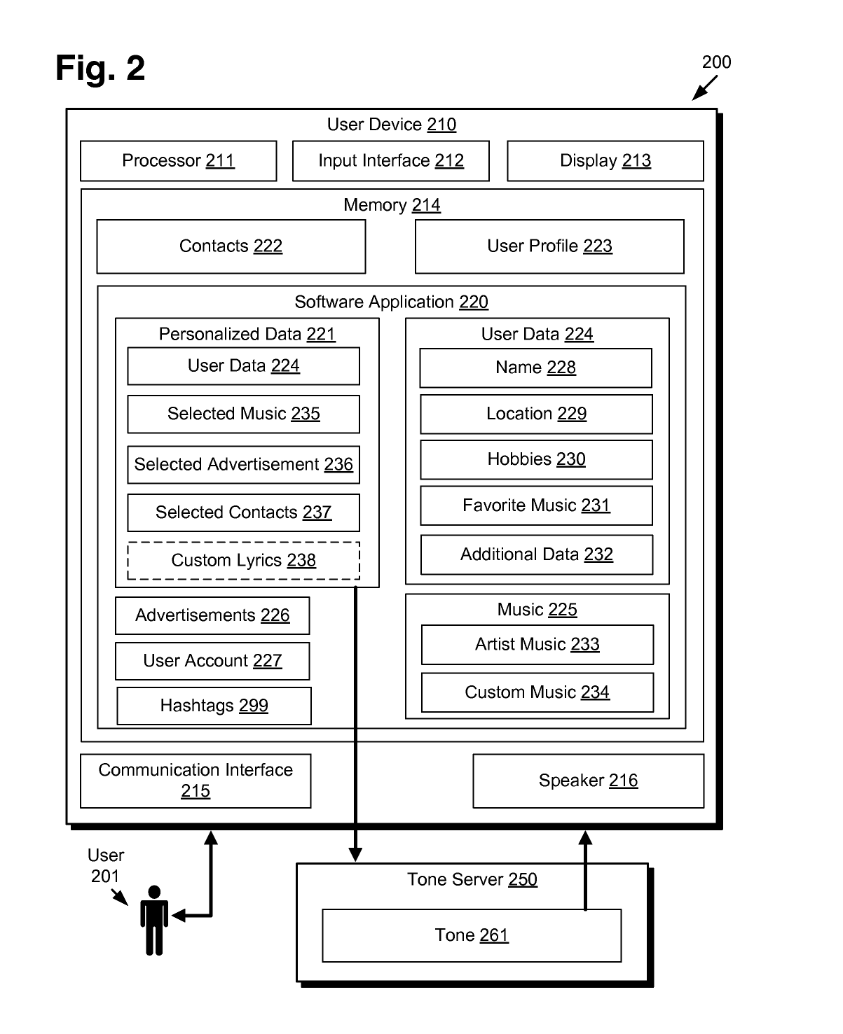

FIG. 2 presents an example of a user device that may be used to generate personalized tones, according to one implementation of the present disclosure. System 200 of FIG. 2 includes user 201, user device 21, and tone server 250. User device 210 includes processor 211, input interface 212, display 213, memory 214, communication interface 215, and speaker 216. Memory 214 includes software application 220, contacts 222, and user profile 223. Software application 220 includes personalized data 221, user data 224, music 225, advertisements 226, hashtags 299, and user account 227. Personalized data 221 includes user data 224, selected music 235, selected advertisement 236, selected contacts 237, and custom lyrics 238. User data 224 includes name 228, location 229, hobbies 230, favorite music 231, and additional data 232. Music 225 includes artist music 233 and custom music 234. Tone server 250 includes tone 261.

With regard to FIG. 2, it should be noted that user 201, user device 210, software application 220, personalized data 221, tone server 250, and tone 261 correspond respectively to user device 110, software application 120, personalized data 121, tone server 150, and tone 161 from FIG. 1. Furthermore, many features have been left out of FIG. 2 for clarity purposes.

User device 210 may include a mobile phone, a personal computer, a server, a tablet, or any other electronic device capable of executing software application 220. As illustrated in FIG. 2, user device 210 includes display 213 and input interface 212. Input interface 212 may include, for example, a keyboard, a mouse, a game controller, a touch-screen input, a thermal and/or electrical sensor, or any other device capable of accepting user input for user with user device 210. Display 213 may include a liquid crystal display (“LCD”), a light-emitting diode (“LED”), an organic-emitting diode (“OLED”), or another suitable display screen built into user device 210 that performs physical transformation of signals to light. In some implementations, display 213 may also be touch sensitive and may serve as one of the devices included in input interface 212.

User device 210 may belong to an organization, such as organization 190 in FIG. 1, or may belong to an individual user, such as user 101 in FIG. 1. In some implementations, user device 210 may be shared among more than one user, and in such an implementation personalized data 221 may include information pertaining to one or more of the shared users.

Also illustrated in FIG. 2, user device 210 includes processor 211 and memory 214. Processor 211 may be configured to access memory 214 to store received input or to execute commands, processes, or programs stored in memory 214, such as software application 220. Processor 211 may correspond to a processing device, such as a microprocessor or similar hardware processing device, or a plurality of hardware devices. Memory 214 is a sufficient memory capable of storing commands, processes, and programs for execution by processor 211.

Also illustrated in FIG. 2, user device 210 includes communication interface 215. User device 210 may transmit personalized data 221 to tone server 250 and receive tone 261 from tone server 250 using communication interface 215. As such, in the implementation of FIG. 2, communication interface 215 includes any device that is capable of both transmitting data with a transmitter and receiving data with a receiver. For example, communication interface 215 may utilize, for example, one or more of Wireless Fidelity (“Wi-Fi”), Worldwide Interoperability for Microwave Access (“WiMax”), Bluetooth, or any other wired or wireless technology.

Also illustrated in FIG. 2, user device 210 includes software application 220. As discussed above, user 201 of user device 210 may utilize software application 220 to create personalized tones, such as tone 261. In order to create tone 261, user 201 first has to generate and transmit personalized data 221 to tone server 250. As illustrated in the implementation of FIG. 2, personalized data 221 includes user data 224, selected music 235, selected advertisement 236, selected contacts 237, and optionally custom lyrics 238.

User data 224 may include data corresponding to questions about user 201 in possession of user device 210. As illustrated in FIG. 2, user data 224 includes name 228, location 229, hobbies 230, favorite music 231, and additional data 232. Name 228 may include the name of user 201. For example, name 228 may include the first name of user 201, the first and last name of user 201, or any nicknames that user 201 may go by. Location 229 may include the location of user 201. For example, location 229 may include a geographic location of user 201, such as the city, state, or country user 201 is located in.

Hobbies 230 may include any hobbies that user 201 may have. For example, hobbies may include the user's favorite sports, sports teams, activities, or any other hobbies of user 201. Favorite music 231 may include the favorite music of user 201. For example, favorite music 231 may include the user's favorite genre of music or the user's favorite band or song. Finally, additional data 232 may include any other additional data about user 201 that software application 220 may use when creating tone 261. For example, additional data 232 may include, but is not limited to, the gender of user 201, the age of user 201, and what school user 201 goes to.

It should be noted that, in one implementation, software application 120 may use user profile 223 when answering one or more of the questions from user data 224. For example, user profile 223 may include one or more of the name of user 201, the location of user 201, hobbies of user 201, favorite music for user 201, or other additional data about user 201. In such example, software application 220 may use user profile 223 when determining one or more of name 228, location 229, hobbies 230, favorite music 231, and additional data 232.

Selected music 235 may include either an entire song, only part of a song, or background/instrumental music from a song that is selected from music 225 by user 201, where music 225 includes artist music 233 and custom music 234. Artist music 233 may include music that is written and released to the public from singers and song writers. For example, artist music 233 may include any music that is played on the radio, any music that may be bought from stores (for example on a compact disc), or any music that may be purchased over the Internet. Custom music 234 may include any music that is created specifically for personalized tones. For example, the operator of tone server 250 may generate custom music 234 that may be used by users using software application 220. The operator of tone server 250 may include a company or business in charge of creating and managing software application 220. In such an example mobile device 210 may download custom music 234 from tone server 250. For another example, user 201 using software application 220 may create his or her own custom music 234 using software application 220 to use in tone 261.

Selected advertisements 236 may include one or more of advertisements 226 selected by user 201 to be used in tone 261. In one implementation, advertisements 226 may include a short clip about one or more sponsors for software application 220. In such an implementation, selected advertisement 236 corresponds to one or more of the short clips from one or more of the sponsors, as selected by user 201. However, in another implementation, advertisements 226 may merely include the name of the sponsors of software application 220. In such an implementation, selected advertisement 236 corresponds to one or more of the sponsors as selected by user 201.

Selected contacts 237 may include one or more contacts selected by user 201, where selected contacts are contacts that user 201 wants to receive tone 261 after tone 261 is generated by tone server 250. For example, selected contacts 237 may include the names of friends and family of user 201, the phone numbers for friends and family of user 201, the email addresses of friends and family of user 201, or any other contact information user 201 can provide that may be used to transmit tone 261 to selected contacts 237.

It should be noted that, in one implementation, software application 220 may use contacts 222 to provide user 201 with a list of possible contacts for selected contacts 237. In such an implementation, contacts 222 may include any contacts that user 201 has stored in user device 210. For example, contacts 222 may include the names, phone numbers, and/or email addresses of contacts for user 201. In yet another implementation, software application may randomly select a certain number of contacts 222 for including in selected contacts 237. In such an implementation, user 201 may agree to have some of contacts 222 selected by software application 220 in exchange for receiving tone 261.

Also illustrated in FIG. 2, personalized data 224 optionally includes custom lyrics 237. Custom lyrics 238 may include lyrics written by user 201 (or someone user 201 knows) that user 201 wants to be included in tone 261. For example, user 201 may want to include ten seconds of his or her own lyrics in tone 261. In such an example, user 201 would include the lyrics in personalized data 221 as custom lyrics 238 and tone server 250 would include at least part of the lyrics in tone 261 when tone server 250 is generating tone 261.

Also illustrated in FIG. 2, software application 220 includes user account 227. User account 227 may include an account used by user 201 when creating different tones with software application 220. For example, in order to create tone 261, user 201 may first have to log into user account 227. In such an example, user 201 may have to provide a username and password (or other credentials) for logging into user account 227. For another example, when tone server 250 generates tone 261 and transmits a notification to user device 210 that tone 261 is finished, software application 220 may notify user 201 that tone 261 is ready. In such an example, user 201 may have to log into user account 227 using a username and password in order to download tone 261.

It should be noted that in some implementations, personalized data 221, including user data 224, may be encrypted on user device 210 before being transmitted to tone server 250. In such an implementation, tone server 250 can use and transmit the encrypted personalized data 221 to organizations, such as organization 190 of FIG. 1, to allow for more targeted advertisements by the organizations.

Also illustrated in FIG. 2, software application 220 includes hashtags 299. Hashtags 299 enable searching of software application 220, social networking, or other databases for tones, including tone 261. For example, user 201 may search for other tones associated with a given advertisement by using hashtags 299 in order to determine which of advertisements 226 to select as selected advertisement 236 for tone 261. User 201 may also search for tones created by friends of user 201, or by organizations, such as organization 190 in FIG. 1.

In one example, if user 201 is searching for tones associated with Advertisement A, user may enter into a search on software application 220 “#advertisementA” or if user wants to search for a tone of Friend A, user 201 may enter into a search on software application 220 “#friendAtone”, for example. In response to user 201 entering one of the above hashtags, software application 220 searches hashtags 299 for tone that are tagged with the above hashtags, for example. As a result, user 201 is able to view and listen to tones associated with advertisements 226 and friends of user 201.

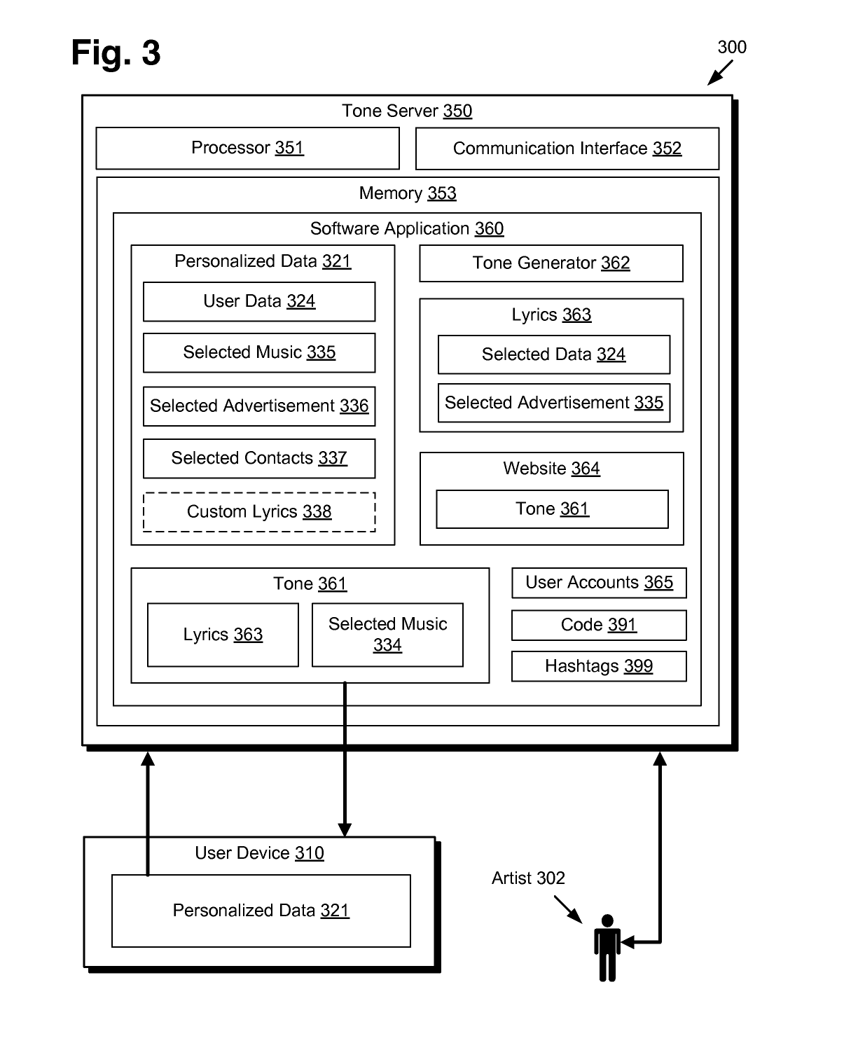

FIG. 3 presents an example of a server that may be used to generate personalized tones, according to one implementation of the present disclosure. System 300 of FIG. 3 includes artist 302, user device 310, and tone server 350. User device 310 includes personalized data 321. Tone server 350 includes processor 351, communication interface 352, and memory 353. Memory 353 includes software application 360, which includes personalized data 321, tone 361, tone generator 362, lyrics 363, website 364, code 391, hashtags 399, and user accounts 365. Personalized data 321 includes user data 324, selected music 335, selected advertisement 336, selected contacts 337, and custom music 338. Tone 361 includes selected music 334 and lyrics 363. Lyrics 363 include selected data 324 and selected advertisement 335. Website 364 includes tone 361.

With regard to FIG. 3, it should be noted that artist 302, user device 310, personalized data 321, tone server 350, code 391, and tone 361 correspond respectively to artist 102, user device 110, personalized data 121, tone server 150, code 191, and tone 161 from FIG. 1. Furthermore, user device 310, personalized data 321, user data 324, selected music 335, selected advertisement 336, selected contacts 337, custom lyrics 338, tone server 350, hashtags 399, and tone 361, correspond respectively to user device 210, personalized data 221, user data 224, selected music 235, selected advertisement 236, selected contacts 237, custom lyrics 238, tone server 250, hashtags 299, and tone 261 from FIG. 2. Finally, certain features have been left out of FIG. 3 for clarity purposes.

As illustrated in FIG. 3, tone server 350 includes processor 351 and memory 353. Processor 351 may be configured to access memory 353 to store received input or to execute commands, processes, or programs stored in memory 353, such as software application 360. Processor 351 may correspond to a processing device, such as a microprocessor or similar hardware processing device, or a plurality of hardware devices. Memory 353 is a sufficient memory capable of storing commands, processes, and programs for execution by processor 351.

Also illustrated in FIG. 3, tone server 350 includes communication interface 352. Tone server 350 may receive personalized data 321 from user device 310 and transmit tone 361 to user device 310 using communication interface 352. As such, in the implementation of FIG. 3, communication interface 352 includes any device that is capable of both transmitting data with a transmitter and receiving data with a receiver. For example, communication interface 352 may utilize, for example, one or more of Wireless Fidelity (“Wi-Fi”), Worldwide Interoperability for Microwave Access (“WiMax”), Bluetooth, or any other wired or wireless technology.

Also illustrated in FIG. 3, tone server 350 includes tone generator 362. Server 350 may utilize tone generator 362 to generate tone 361 after receiving personalized data 321 from user device 310. In order to generate tone 361, tone server 350 first receives lyrics 363 from artist 302.

In one implementation, tone server 350 transmits personalized data 321 to artist 302. In such an implementation, artist utilizes user data 324 and selected advertisement 336 of personalized data 321 to create lyrics 363. Artist 363 then records lyrics 363 using any device capable of recording lyrics 363 and transmits lyrics 363 to tone server 350. As such, in this implementation, artist 302 has created lyrics 363 that are personalized for the user of user device 310, where lyrics 363 include at least in part selected data 324 about the user and selected advertisement 335 from the user. Artist 302 includes additional lyrics created by artist 302 which are included in recorded lyrics 363 so that lyrics 363 can be used to generate tone 361.

In another implementation, tone server 350 uses personalized data 321 received from user device 310 and creates lyrics 363. In such an implementation, tone server 350 may use user data 324 and selected advertisement 336 to create lyrics 363. Tone server 350 may then transmit lyrics 363 to artist 302 so that artist 302 can record lyrics 363. Artist 302 then transmits lyrics 363, which are sang by artist 302, back to tone server 350. Artist 302 may receive lyrics 363 on a user device in possession of artist 302. As such, in this implementation, tone server 350 has created lyrics 363 that are personalized for the user of user device 310, where lyrics 363 again include at least in part selected data 324 about the user and selected advertisement 335 from the user. Furthermore, artist 302 has recorded lyrics 363 so that lyrics 363 can be used to generate tone 361.

In another implementation, personalized data 321 is encrypted by tone server 350, or personalized data 321 is received as encrypted personalized data 321 from at least one user device, including user device 310. In such an implementation, tone server 350 may utilize the encrypted personalized data 321 to generate information for organizations, such as organization 190 in FIG. 1, so that the organizations can provide more accurate and targeted advertisements for their customer and/or user base.

For example, the organization may send tone 361 including code 391 to Customer A, and Customer A may consequently downloads their own tone including code 391, and finally each of Customer A's friends and acquaintances may consequently downloads their own tone including code 391. In such an example, tone server 350 utilize personalized data 321 of each of the customers and/or users that generated tones including code 391 to generate information for the organization to utilize in targeting their advertisements for their customer and/or user base.

It should be noted that in some implementations, artist 302 and software application 220 will not include selected advertisement 335 in lyrics 363. In such implementations, when selected advertisement 336 includes a short clip that is already created by a sponsor of software application 220, tone generator 362 will input the short clip directly into tone 361. Furthermore, in such implementations, when selected advertisement 336 merely includes the name of a sponsor of software application 220, tone generator 362 will selected an advertisement from an advertisement database (not shown) that corresponds to the sponsor and place that advertisement in tone 361.

In yet another implementation, no advertisement is included in lyrics 363, and lyrics 363 include only lyrics generated based on user data 324 and/or custom lyrics 338.

Continuing with the generation of tone 361, after tone server 350 receives lyrics 363 from artist 302, tone generator 362 then uses lyrics 363 and selected music 334 to generate tone 361. For example, in one implementation, where selected music 335 includes background/instrumental music for a song, tone generator 362 combines the background music from selected music 334 with lyrics 363 to generate tone 361. In such an implementation, tone 361 thus includes the background music with lyrics 363 sung by artist 302. As such, tone 361 includes a personalized tone that is created by the user of user device 301.

In some implementations, artist 302 combines the background/instrumental music from the song with lyrics 363 and transmits the combination to tone server 350.

Also illustrated in FIG. 3, tone server 350 includes user accounts 365. User accounts 365 may include profiles for all of the users of tone server 350. For example, and as discussed above, the user of user device 310 may log into his or her account to create tone 361. In such an example, user accounts 365 would include the user account for the user of user device 310.

Also illustrated in FIG. 3, tone server includes website 364, which includes tone 361. Website 364 may include a website that is hosted by tone server 350 for which electronic devices can go to in order to download tone 361. For example, tone server 350 may provide user device 310 (or other electronic devices, such as electronic devices 180 from FIG. 1) with the Uniform Resource Locator (URL) for website 364, either through a short message service or an email address. User device 310 (or the other electronic devices) may then use URL to access webpage 364 and download tone 361 directly from webpage 364. As such, user device 310 (and other electronic devices) can easily download and listen to tone 361.

Also illustrated in FIG. 3, tone server 350 includes code 391. Code 391 is generated by tone server 350 and specific to a user, such as user 201 of FIG. 2, or to an organization, such as organization 190 of FIG. 1. In some implementations, code 391 is included with tone 361 when tone 361 is generated. Code 391 may be embedded as metadata within tone 361, or sent in addition to tone 361 to each user that receives tone 391. Similar to the example provided above with reference to code 191 and organization 190 in FIG. 1, code 391 can be sent with each tone generated for a network of users and/or customers that download software application 360 downstream of the original customers and/or users that receive tone 361 from tone server 350.

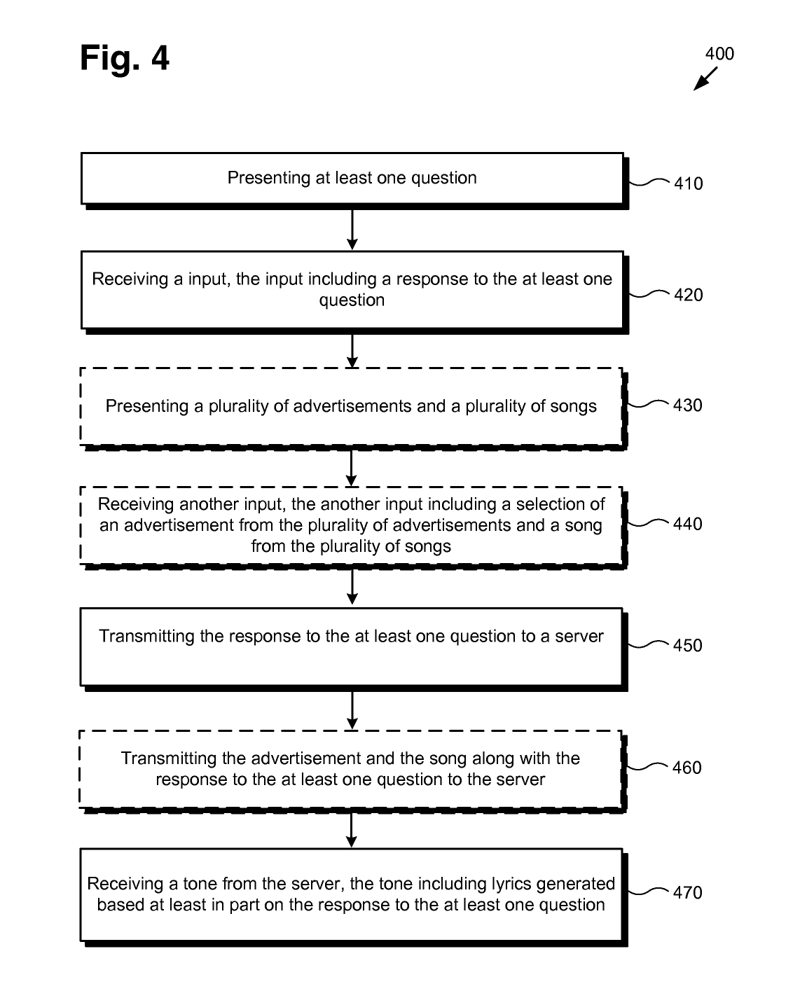

FIG. 4 shows a flowchart illustrating a method for using a user device to generate personalized tones, according to one implementation of the present disclosure. The approach and technique indicated by flowchart 400 are sufficient to describe at least one implementation of the present disclosure, however, other implementations of the disclosure may utilize approaches and techniques different from those shown in flowchart 400. Furthermore, while flowchart 400 is described with respect to FIG. 2, the disclosed inventive concepts are not intended to be limited by specific features shown and described with respect to FIG. 2. Furthermore, with respect to the method illustrated in FIG. 4, it is noted that certain details and features have been left out of flowchart 400 in order not to obscure the discussion of inventive features in the present application.

Referring now to flowchart 400 of FIG. 4, flowchart 400 (at 410) includes displaying at least one question. For example, processor 211 of user device 210 may execute software application 220 to display at least one question from user data 224 to user 201. As illustrated in FIG. 2, the at least one question can include a query for name 228 of user 201, location 229 or user 201, hobbies 230 of user 201, favorite music 231 of user 201, and any additional data 232 about user 201.

Flowchart 400 (at 420) further includes receiving an input, the input including a response to the at least one question. For example, processor 211 of user device 210 may execute software application 220 to receive a user response from user 201, the user response including a response to the at least one question from user data 224. As discussed above, in one implementation, software application 220 may utilize user profile 223 for responding to the questions in user data 224.

Flowchart 400 (at 430) optionally includes presenting a plurality of advertisements and a plurality of songs. For example, processor 211 of user device 210 may execute software application 220 to present advertisements 226 and music 225 to user 201. As discussed above, advertisements 226 may include short advertisement clips from sponsors of software application 220 or just the names of the sponsors. Furthermore, music 225 may include artist music 233 and custom music 234, including the entire song or just an instrumental of the song. It should be noted that to present, or presenting, as used herein, includes displaying or rendering the content.

Flowchart 400 (at 440) optionally includes receiving another input, the input including a selection of an advertisement from the plurality of advertisements and a song from the plurality of songs. For example, processor 211 of user device 210 may execute software application 220 to receive another user input from user 201, the another user input including a selection of selected advertisement 236 from advertisements 226 and selected music 235 from music 225.

Flowchart 400 (at 450) further includes transmitting the at least one response to the at least one question to a server. For example, processor 211 of user device 210 may execute software application 220 to transmit user data 224 to tone server 250. As illustrated in FIG. 2, user data 224 may be transmitted to tone server 250 within personalized data 221 over a network, such as network 105 from FIG. 1.

Flowchart 400 (at 460) optionally includes transmitting the advertisement and the song along with the response to the at least one question to the server. For example, processor 211 of user device 210 may transmit selected advertisement 236 along with selected music 235 along with user data 224 to tone server 250. As illustrated in FIG. 2, selected advertisement 236 and selected music 235 may be included within personalized data 221 along with user data 224 for transmission to tone server 250.

Flowchart 400 (at 470) further includes receiving a tone from the server, the tone including lyrics generated based at least in part on the response to the at least one question. For example, processor 211 of user device 210 may execute software application 220 to receive tone 261 from tone server 250 in response to transmitting user data 224 to tone server 250, tone 261 including lyrics created using user data 224. As illustrated in FIG. 3, lyrics 363 may be sang on tone 261 by artist 302.

Furthermore, in implementations that include selected advertisement 236 and selected music 235 being transmitted in personalized data 221 along with user data 224, the lyrics for tone 261 may further be created using selected advertisement 236. In such implementations, tone 261 further includes the instrumentals of selected music 235. For example, tone server 250 may generate tone 261 such that the lyrics sang by the artist are sung over the instrumentals of selected music 235.

It should be noted that in some implementations, selection of user data 224, advertisement 236, and selected music 235 may be made automatically by tone server 250 based on user profile 223 and/or other information available to tone server 250.

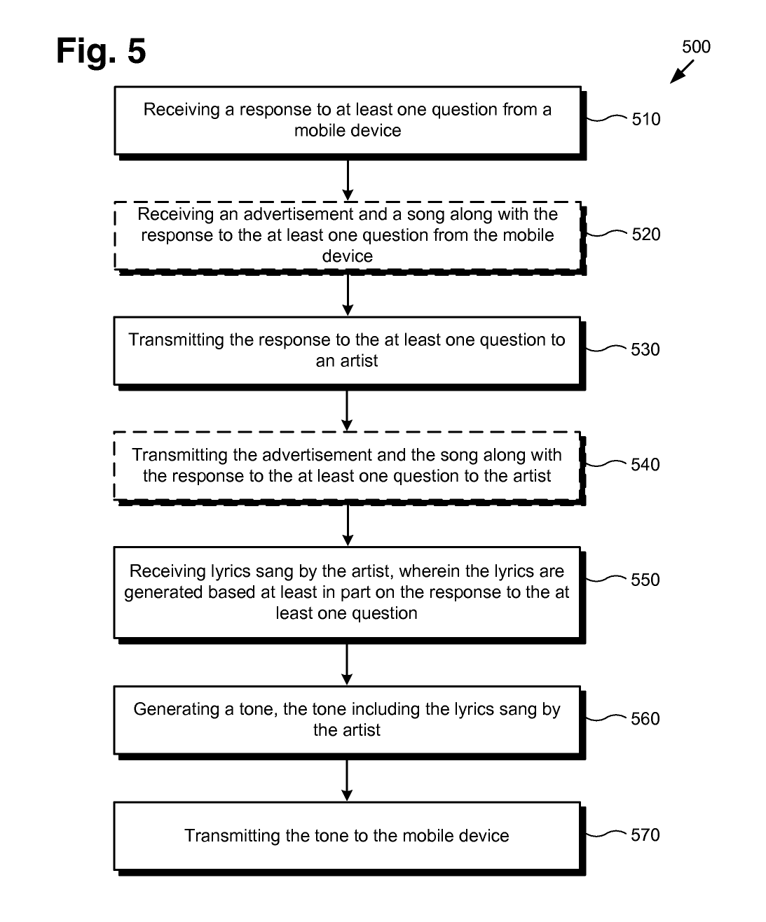

FIG. 5 shows a flowchart illustrating a method for a server to generate personalized tones, according to one implementation of the present disclosure. The approach and technique indicated by flowchart 500 are sufficient to describe at least one implementation of the present disclosure, however, other implementations of the disclosure may utilize approaches and techniques different from those shown in flowchart 500. Furthermore, while flowchart 500 is described with respect to FIG. 3, the disclosed inventive concepts are not intended to be limited by specific features shown and described with respect to FIG. 3. Furthermore, with respect to the method illustrated in FIG. 5, it is noted that certain details and features have been left out of flowchart 500 in order not to obscure the discussion of inventive features in the present application.

Referring now to flowchart 500 of FIG. 5, flowchart 500 (at 510) includes receiving a response to at least one question from a mobile device. For example, processor 351 of tone server 350 may receive user data 324 from mobile device 310. As illustrated in FIG. 3, user data 324 may be received from mobile device 310 within personalized data 321. Furthermore, and as discussed above, user data 324 may include the name of the user of user device 310, the location of the user, hobbies for the user, the favorite music of the user, and any additional data for the user.

Flowchart 500 (at 520) optionally includes receiving an advertisement and a song along with the response to the at least one question from the mobile device. For example, processor 351 of tone server 350 may receive selected advertisement 336 and selected music 335 along with user data 324 from user device 310. As illustrated in FIG. 3, selected advertisement 336 and selected music 335 may be received within personalized data 321 along with user data 324.

Flowchart 500 (at 530) further includes transmitting the response to the at least one question to an artist. For example, processor 351 of tone server 350 may transmit user data 324 to artist 302. As discussed above, tone server 350 may transmit user data 324 within personalized data 321 to artist 302. Furthermore, transmitting user data 324 to artist 302 may include transmitting user data 324 to an electronic device (not shown) in possession of artist 302.

Flowchart 500 (at 540) optionally includes transmitting the advertisement and the song along with the response to the at least one question to the artist. For example, processor 351 of tone server 350 may transmit selected advertisement 336 and selected music 335 along with user data 321 to artist 302. As discussed above, selected advertisement 336 and selected music 335 may be transmitted within personalized data 321 along with user data 324 to artist 302.

Flowchart 500 (at 550) further includes receiving lyrics sang by the artist, wherein the lyrics are generated at least in part on the response to the at least one question. For example, processor 351 of tone server 350 may receive lyrics 363 from artist 302 in response to the transmitting of user data 324 to artist 302, wherein lyrics 363 are created using selected data 324. As discussed above, in one implementation, artist 302 creates lyrics 363 using at least in part information included in user data 324.

Furthermore, in implementations where tone server 350 transmits selected advertisement 336 along with user data 324 to artist 302, lyrics 363 are further created using selected advertisement 335. In such implementations, lyrics 363 may include a few seconds dedicated to selected advertisement 335, such as the first eight to ten seconds of lyrics 363, for example.

Flowchart 500 (at 560) further includes generating a tone, the tone including the lyrics sang by the artist. For example, processor 351 of tone server 350 may execute tone generator 362 to generate tone 361, wherein tone 361 includes lyrics 363 sang by artist 302. Furthermore, in implementations where tone server 350 receives selected music 335 from user device 310, tone generator 362 may further generate tone 361 to include instrumentals from selected music 335. In such implementations, tone 361 may include lyrics 363 sang over the instrumentals from selected music 335.

Flowchart 500 (at 570) further includes transmitting the tone to the mobile device. For example, processor 351 of tone server 350 may transmit tone 361 to mobile device 310. As discussed above, transmitting tone 361 to user device 310 may include transmitting a notification to user device 310 that directs user device 310 to website 364 for downloading tone 361. Furthermore, tone server 350 may transmit notifications to contacts of user device 310 so that the contacts can also receive tone 361 from tone server 350.

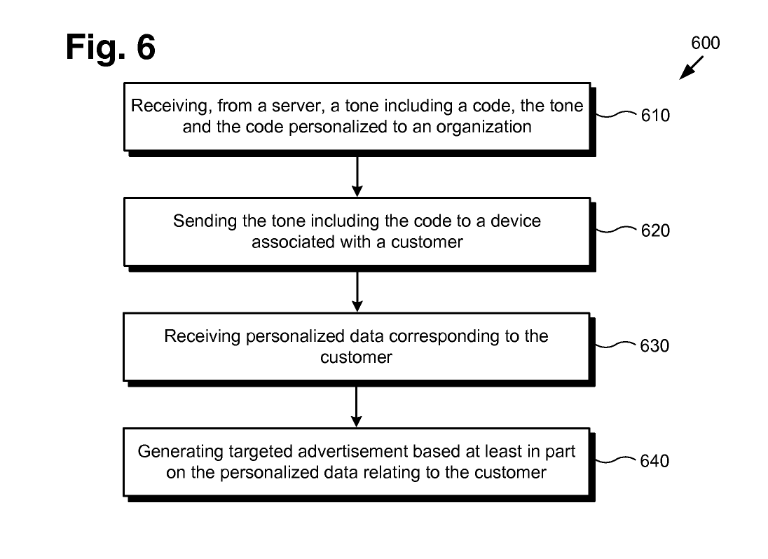

FIG. 6 shows a flowchart illustrating a method for an organization to create a network of customers and/or users to generate targeted advertisements, according to one implementation of the present disclosure. The approach and technique indicated by flowchart 600 are sufficient to describe at least one implementation of the present disclosure, however, other implementations of the disclosure may utilize approaches and techniques different from those shown in flowchart 600. Furthermore, while flowchart 600 is described with respect to FIG. 1, the disclosed inventive concepts are not intended to be limited by specific features shown and described with respect to FIG. 1. Furthermore, with respect to the method illustrated in FIG. 6, it is noted that certain details and features have been left out of flowchart 600 in order not to obscure the discussion of inventive features in the present application.

Flowchart 600 (at 610) includes receiving, from a server, a tone including a code, the tone and the code personalized to an organization. For example, organization 190 downloads software application 160 and consequently receives tone 161 and code 191 personalized to organization 190. Similar to personalized data 121 on user device 110, tone 161 is generated by tone server 150 using personalized data relating to organization 190. In addition, as discussed above, tone server 150 may include code 191 with tone 161.

Flowchart 600 (at 620) further includes sending the tone including the code to a device associated with a customer. For example, organization 190 may send tone 161 including code 191 to user device 110 or any of electronic devices 180, so long as user device 110 and any of electronic devices 180 are in possession of a customer of organization 190.

Flowchart 600 (at 630) further includes receiving personalized data corresponding to the customer. For example, tone server 150 may send personalized data 121 to organization 190, and organization 190 may receive personalized data 121 so long as user device 110 belongs to user 101 who is a customer of organization 190. As discussed above, because code 191 is transmitted with each downstream customer and/or user associated with tone 161, tone server 150 has access to the personalized data of all of the downstream customer and/or users, including personalized data 121 of user device 110 belonging to user 101. Tone server 150 may encrypt all of the personalized data of each downstream customer and/or user in order to transmit only consensus data for reception by organization 190.

Flowchart 600 (at 640) further includes generating targeted advertisements based at least in part on the personalized data relating to the customer. For example, organization 190 may generate targeted advertisements based on at least personalized data 121 of user 101 and the personalized data of other downstream customers and/or users of tone 161. As such, organization 190 is able to provide more accurate, targeted, and meaningful advertisements for future sales and/or to spread awareness of organization 190 on a more personalized level.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A user device comprising:
a memory storing a software application; and
a processor configured to execute the software application to:
present at least one question;
receive a first input, the first input including a response to the at least one question;
transmit the response to the at least one question to a server; and
receive a tone from the server, the tone including lyrics generated based at least in part on the response to the at least one question.

2. The user device of claim 1, wherein the at least one question includes a query for at least one of a name, a location, or a hobby.

3. The user device of claim 1, wherein before the receiving the tone from the server, the processor is further configured to execute the software application to:
present a plurality of advertisements;
receive a second input, the second input including a selection of an advertisement from the plurality of advertisements; and
transmit the advertisement along with the response to the at least one question to the server,
and wherein the lyrics are further based at least in part on the advertisement.

4. The user device of claim 1, wherein the lyrics are sang by an artist.

5. The user device of claim 1, wherein before the receiving the tone from the server, the processor is further configured to execute the software application to:
present a plurality of songs;
receive a second input, the second input including a selection of a song from the plurality of songs; and
transmit the song along with the response to the at least one question to the server.

6. The user device of claim 5, wherein the tone includes an instrumental of the song.

7. The user device of claim 1, wherein before the receiving the tone from the server, the processor is further configured to execute the software application to:
present a plurality of advertisements;
receive a second input, the second input including a selection of an advertisement from the plurality of advertisements;
present a plurality of songs;
receive a third input, the third input including a selection of a song from the plurality of songs; and
transmit the advertisement and the song along with the response to the at least one question to the server.

8. The user device of claim 7, wherein the lyrics are further based at least in part on the advertisement and the tone include an instrumental of the song.

9. A server comprising:
a memory storing a software application; and
a processor configured to execute the software application to:
receive a response to at least one question from a mobile device;
transmit the response to the at least one question to an artist;
receive lyrics sang by the artist, wherein the lyrics are based at least in part on the response to the at least one question;
generate a tone, the tone including the lyrics sang by the artist; and
transmit the tone to the mobile device.

10. The server of claim 9, wherein before the generating the tone, the processor is further configured to execute the software application to:
receive an advertisement along with the response to the at least one question from the mobile device; and
transmit the advertisement along with the response to the at least one question to the artist, wherein the lyrics are further based at least in part on the advertisement.

11. The server of claim 9, wherein before the generating the tone, the processor is further configured to execute the software application to:
receive a song along with the response to the at least one question from the mobile device; and
transmit the song along with the response to the at least one question to the artist, wherein the tone further includes an instrumental of the song.

12. The server of claim 9, wherein to generate the tone, the processor is further configured to execute the software application to:
receive an advertisement and a song along with the response to the at least one question from the mobile device; and
transmit the advertisement and the song along with the response to the at least one question to the artist, wherein the lyrics are further based at least in part on the advertisement and the tone further includes an instrumental of the song.

13. A method for creating a tone, the method comprising:
presenting at least one question;
receiving a first input, the first input including a response to the at least one question;
transmitting the response to the at least one question to a server; and
receiving the tone from the server, the tone including lyrics based at least in part on the response to the at least one question.

14. The method of claim 13, wherein the at least one question includes a query for at least one of a name, a location, or a hobby.

15. The method of claim 13, wherein the lyrics are sang by an artist.

16. The method of claim 13, wherein before the receiving the tone from the server, the method further comprises:
presenting a plurality of advertisements;
receiving a second input, the second input including a selection of an advertisement from the plurality of advertisements; and
transmitting the advertisement along with the response to the at least one question to the server,
and wherein the lyrics are further based at least in part on the advertisement.

17. The method of claim 13, wherein before the receiving the tone from the server, the method further comprises:
presenting a plurality of songs;
receiving a second input, the second input including a selection of a song from the plurality of songs; and
transmitting the song along with the response to the at least one question to the server.

18. The method of claim 17, wherein the tone further includes an instrumental of the song.

19. The method of claim 13, wherein before the receiving of the tone from the server, the method further comprising:
presenting a plurality of advertisements;
receiving a second input, the second input including a selection of an advertisement from the plurality of advertisements;
presenting a plurality of songs;
receiving a third input, the third input including a selection of a song from the plurality of songs; and
transmitting the advertisement and the song along with the response to the at least one question to the server.

20. The method of claim 19, wherein the lyrics are further based at least in part on the advertisement and the tone further includes an instrumental of the song.
